(19) United States
(12) Patent Application Publication
(10) Pub. No.: US 2020/0327596 A1
(43) Pub. Date: Oct. 15, 2020

(54) A method to classify and/or search for products/services depending on emotional states that a person wants to feel

(71) Applicant: TIMINA S.R.L., Castelnuovo Berardenga (IT)

(72) Inventor: Christian Betti, Castelnuovo Berardenga (IT)

(21) Appl. No.: 16/093,957

(22) PCT Filed: Apr. 11, 2017
(86) PCT No.: PCT/IB2017/052076

§ 371 Date: Oct. 15, 2018

(30) Foreign Application Priority Data
May 6, 2016 (IT) 102016000046988

(51) Int. Cl. G06Q 30/06; G06Q 30/02

(52) U.S. Cl. CPC G06Q 30/0627; G06Q 30/0282

(57) ABSTRACT

A method of reviewing a product or a service includes accessing a server storing a database that memorizes or processes data using an electronic device that connects to the internet; sending to the server, through the electronic device, a review request of a pre-determined product or service to receive back a sequence of elements of judgment, correlated to the product or service, and rating it between a pre-established minimum value and a maximum value; inserting, through the electronic device, the numerical evaluation of each element of judgment and sending it to the server; processing the evaluation by the server using an algorithm that extrapolates a classification of elements of judgment correlated to the product or service based on the received evaluation and an eventual previous evaluations, wherein the elements of judgment are selected so that each one of them is an indicative term of an emotional state.

### TECHNICAL FIELD

The present invention refers to the technical field of systems for classification and evaluation of products and services in general.

In particular, the invention refers to an innovative system for reviewing/classifying products and services, in particular food and wine products.

### BACKGROUND ART

Nowadays, it is known that millions of people are influenced negatively by stress in terms of health and they often have to turn to medical examinations and therapies to try to normalize their values and reduce stress.

The healthcare costs for stress diseases etc. are high and these diseases can have also serious effects in some cases.

Actually, the necessity to direct therapies at totally natural products is increasing, also because these products with correct dose have less side effects.

Therefore, it has been known for a long time by now, that outdoor physical activity, hobbies and good nutrition can contribute to reduce stress values with a huge advantage for health of the single person.

The intimate, deep and basic connection between bodily feelings and emotions is the fundamental principle on which emotional states of each single person are based, with a direct effect on the psychophysical health of the person.

Many food products are element able to activate physiological, neural, somatic, and psychic responses, forming the emotion itself. Pleasure has an essential role and categorizes the related daily experience, at the basis of our emotional state, which has a great influence on our health in its turn (the influence is positive or negative depending on the emotional state and level). For example, if a person feels depressed, eating chocolate helps to escape such a state, as it is known that chocolate has substances which helps to improve the emotional state: this must have a healthy effect on health (also because it is possible to avoid taking chemical medicines, which are expensive and have also remarkable collateral effects).

Other known examples for psychophysical wellness of a person are: trips, shopping, concerts, sport, etc.

Provided that, at the moment there is no system allowing to select easily, depending on needs and when required, products/services able to condition our emotional state and so our health conditions, and direct it toward emotional states that we wish or require at that moment.

Moreover, at the moment it is even difficult to know the therapeutic action of all the substances in the form of food.

For this reason, it is often resorted to medicine treatments with serious effects on health due to side effects.

The known present systems for reviewing, such as TripAdvisor, are not devised to give certain indications for emotional states on product/services and so they cannot be used for the aforementioned purposes. They only describe a product/service through comments and/or purely functional parameters judged by consumers. Such reviewing systems result in being unmethodical, often neither significant not based on parameters bound on emotional states.

In conclusion, known reviewing systems, both for agro-industrial goods and for services, are not useful for giving recommendations of emotional states but the only give simple personal and/or functional opinions.

For example, the publication US2013/080438 is known, representing the preamble of claim 1.

Such a publication describes a poll system of wine products, allowing to give a score to wine by means of properties of the wine itself. Nevertheless, the system, as other known ones, classifies only technical features of the tried wine.

### DISCLOSURE OF THE INVENTION

It is therefore the aim of the present invention to provide a method which solves the aforementioned technical inconveniences.

In particular, the aim of the present invention is to provide a method which allows, on one side, to find easily products/services in general, that can help to modify an emotional state of a person and that, at the same time, allows to interpolate a safe database easily and for certain.

Therefore, these and other aims are obtained with the present method for reviewing a product or a service in general, according to the main claim.

Such a method foresees the phases of:
Access to a server (10) provided with a data-base (20) to memorize/process one or more data, said access being made with an electronic device (1) suitable for connecting through the Internet;
Sending to the server (10), through the electronic device (1), a review request of a pre-determined product/service, the server sending to the device (1) a sequence of elements of judgment correlated to the product/service and to which to attribute a numerical evaluation comprised between a pre-established minimum value and a maximum value;
Insertion, through said electronic device (1), of said numerical evaluation for each element of judgment and sending to the server (10);
Processing of said evaluation by the server (10) through a specific algorithm in such a way as to extrapolate a classification of elements of judgment correlated to said product/service on the basis of the evaluation received and of the eventual previous evaluations.

According to the invention, said elements of judgement are selected in such a manner that each one of them is an indicative term of an emotional state.

In this way, all the above-mentioned technical inconveniences are easily solved.

In particular, such a kind of review allows de facto to provide a database for each product/service, wherein each product is classified depending on predetermined emotional adjectives awakened when trying it and that, at the same time, they can characterize it.

In this way, a database which is updatable each time depending on new reviews is created, thus classifying the product in innovative manner, that is depending on emotional states that it makes feel.

Therefore, it is possible to search for a product and find whether it awakens a mood and which one, depending on the mood that the person wants to feel or inspire.

This result in being a valid alternative to classic medicines.

Further advantages are inferable by the dependent claims.

### BRIEF DESCRIPTION OF DRAWINGS

Further features and advantages of the device, according to the invention, will result to be clearer with the description that follows of some embodiments, made to illustrate but not to limit, with reference to the attached drawings, wherein:

FIG. 1 shows three screenshots (phase a, phase b, phase c) visible on a mobile telephony device according to the present method;

FIG. 2 shows an interaction between the suitable “App” downloaded on the mobile telephony device and the central server 10, which manages the application itself;

FIGS. from 3 to 6 show some details concerning the operation of the algorithm of such a method;

FIGS. from 7 to 11 show schematically the mode of operation of such a method;

FIGS. 12 and 13 are overall flow charts concerning the present method.

### DESCRIPTION OF SOME PREFERRED EMBODIMENTS

The suitably configured present invention, as it is explained in details further in the present description, can be applied to any product, for example food and wine goods, as well as a service.

However, the further explanatory examples refer in detail to the wine product, obviously in a not limiting but clarifying way.

The invention, as it is described in details further, allows de facto to make the following macro-level operations:
Research of a specific product to verify the kind of emotional state and its intensity inspired in the consumer.
Research of a potential product or more potential products that can inspire predetermined emotional states.
Evaluation of the product depending on emotional states felt while consuming it.

Therefore, the method, implemented through a software which is applicable to any technological device where it can work, allows an evaluation of the product depending on predetermined emotional states that it inspires and such an evaluation is then implemented through a predetermined algorithm, thus determining a classification of each reviewed product, by highlighting its emotional states (and related intensities) that he inspires and characterizing it. Each review helps to modify and/or improve the overall judgement which results in being visible/searchable by the user through a research by product or by emotional state at any moment, as already said above.

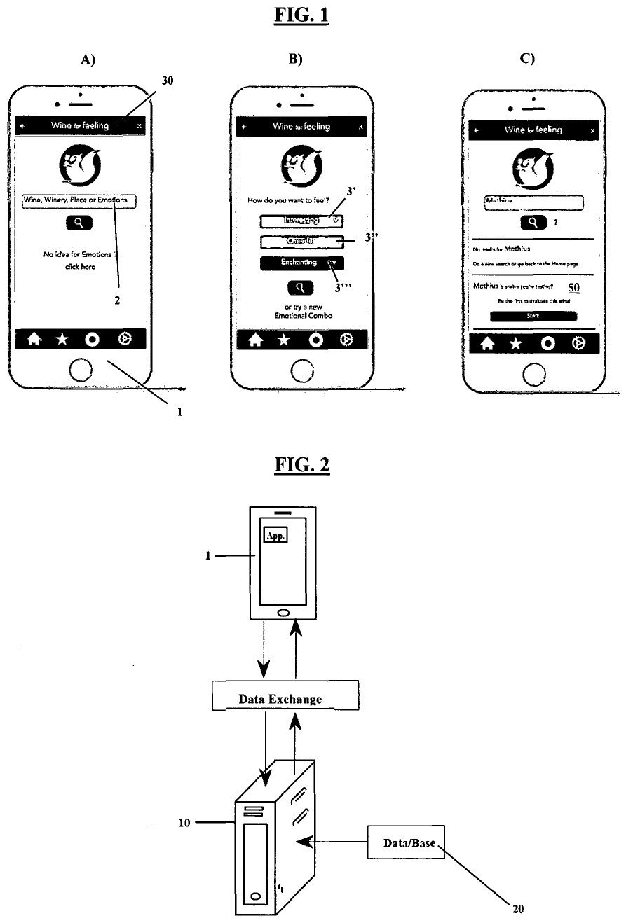

Introduced that, according to the invention, FIG. 1 shows a mobile telephony device, for example an I-Phone, in an unrestrictive manner.

It is known that the aforementioned devices are able to download various applications that work on their operating system. Moreover, they connect and surf on the internet, such that they can exchange data with suitable servers for managing such applications.

Introduced that, the present invention can be implemented in form of an application “App”, which can be downloaded on an own portable device, such as a mobile telephony device indeed, or devices such as notebooks, laptops or similar ones.

However, the invention can work on any kind of processor, able to connect through the internet to a suitable server.

Introduced that, as it is described above, the present invention allows to find wines corresponding with some specific emotional characteristics, once the application has been downloaded and installed.

In that way, the user can easily find specific wines that can help him to reach a predetermined emotional status.

Therefore, this is proved to be a valid alternative to classic medicines which may have various side effects, as already said.

Therefore, FIG. 1 shows a mobile telephony device 1, on which the described software application has been downloaded.

The screenshots of FIG. 1 are not necessarily binding and they can be modified without altering the present inventive concept. They are attached with the specific reference to the field “Wine”, only as an unrestrictive example.

Therefore, FIG. 1 shows the screenshot appearing on the mobile telephony device and allowing to search for products, in order to verify which emotional state it inspires or to search for emotional states, thus finding products inspiring the selected emotional states.

The field 30 shown in FIG. 1A simply refers to a header of the application which works in the field of wine and therefore the research/review results in being restricted to the wine only.

Nevertheless, as already said, it would be possible to widen such a field to any product/service, which could be potentially filtered through the same search bar 30 of FIG. 1.

Always referring to FIG. 1, the application allows to insert the name of the wine which for example someone wants to try in a suitable field (FIG. 1-A).

If, for example, a specific wine brand is inserted, the system searches for it in its own database 20 and displays the emotional state/s and related intensities that such a wine can inspire by drinking it.

Obviously, if the specific product has not been reviewed (as it is explained further), the system could display an invalid result, that is a result wherein the inserted product is not displayed.

For that purpose, always FIG. 1A shows a field that can be selected by the user and that allows to select one or more emotional states that a user would like to feel.

In fact, always FIG. 1 shows a field on which the user can click to enter one or more emotional adjectives:

The field is identified in the following way:

“No idea for the emotions? Click here”

In this case, by clicking on the suitable area, one or more emotional adjectives are displayed and one or more of them can be selected.

More particularly, FIG. 1B shows how the system allows a research which can be launched by starting from emotional states that a person wants to feel.

In that manner, the system displays the related products which awaken such emotional states. If the field is restricted to wines, then the system can display various wine products that inspire such emotional states. In fact, in the example of FIG. 1, the selected field 30 is wine, such that the research made by the system, by starting from inserting the product or from the emotional state that someone wants to feel, is restricted to the wine field.

Only as an example, FIG. 1 shows three field (3′, 3″, 3′″) wherein the following emotional adjectives are highlighted:
Interesting;
Happy;
Captivating;

Therefore, the system is able to search for wines which instill such emotional states.

The example of FIG. 1, with reference to phase C, shows the negative result of the research started by a specific wine product, that is Methius: only for example, a result wherein such a product is not reviewed and therefore would appear as not inserted.

Therefore, the system, as shown in the area 50 of FIG. 1C, allows to review any wine and such a review contributes at the same time to increase and improve the created database.

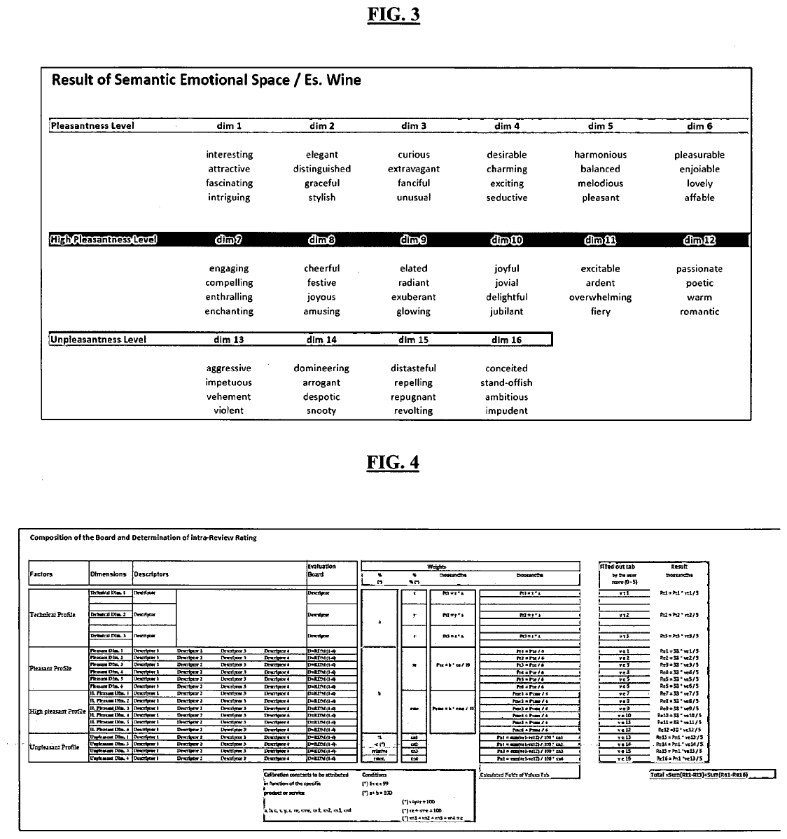

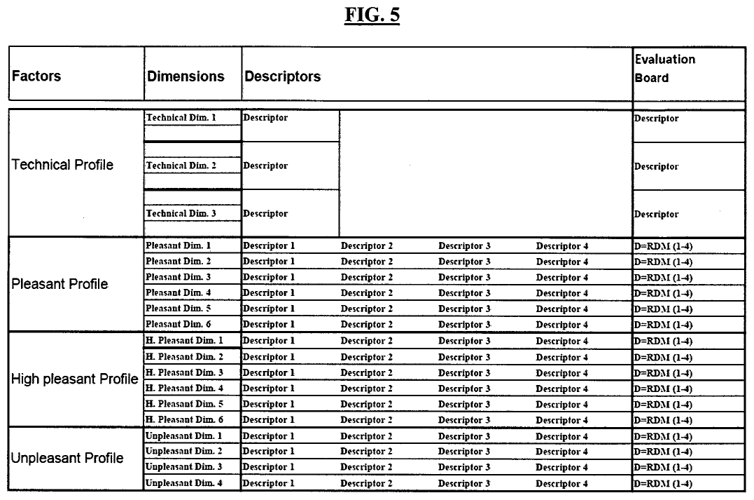

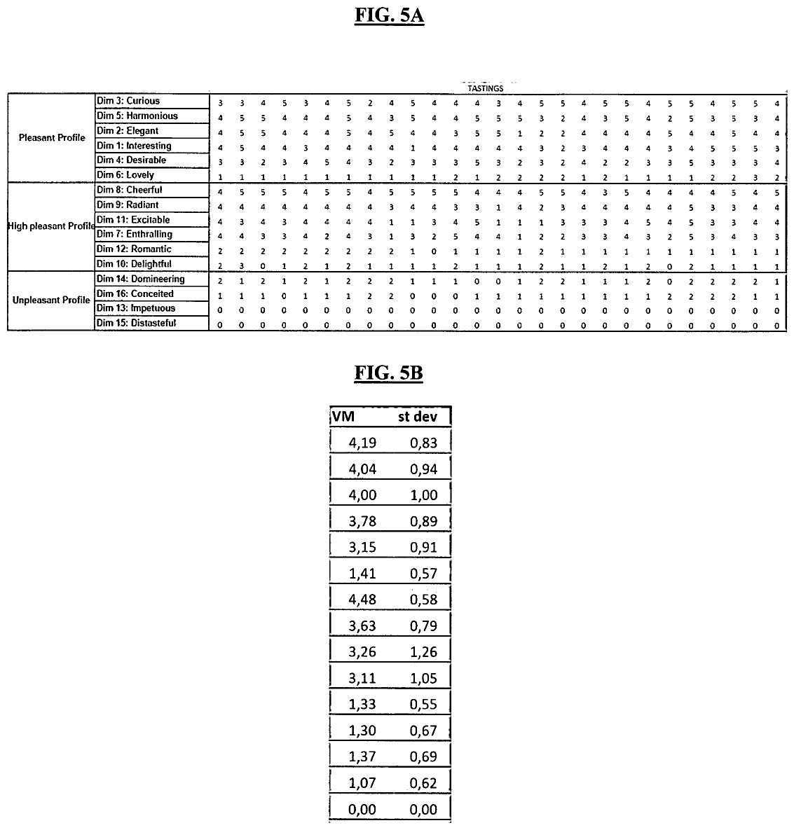

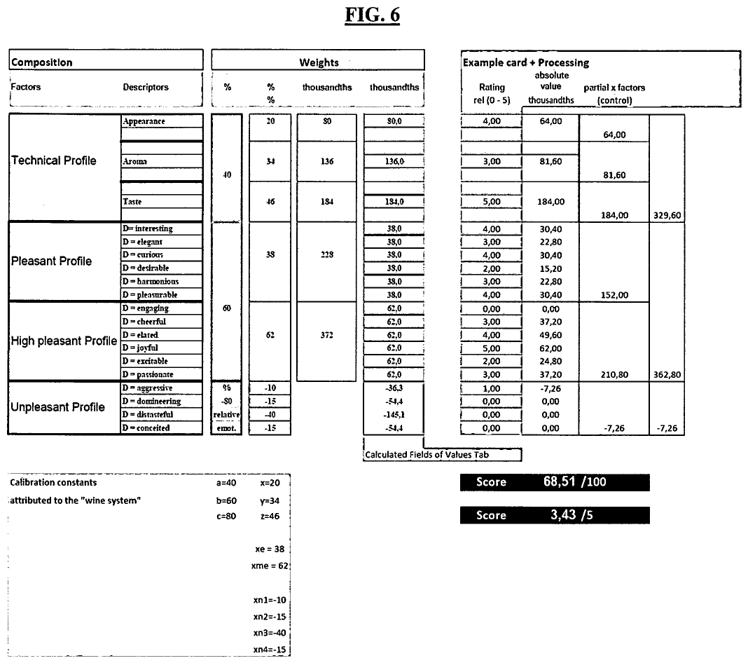

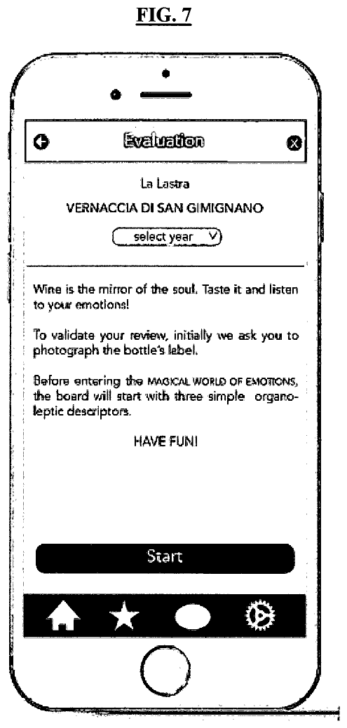

From a purely technical point of view, as shown in FIG. 2, the application connects to a central server 10 which receives the data inserted by the user through the mobile device and gives the required information memorized inside an own database 20.

Obviously, the connection takes place through the internet.

According to the invention, as described below, the database is updatable and is completed by the user themselves depending on a specific algorithm described immediately further, as they make a review. In this manner, the surprising effect of describing and finding typical features of products is possible with a good certainty without the necessity of specific clinical studies which proves such emotional states. Moreover, the data, being processed statistically, result in being filtered for giving objective parameters of judgement. That is different from visualizing a simple list of judgements, as on known reviewing systems now in use.

In particular, the algorithm at the basis of calculations comprises the selection of three levels, as per FIG. 3:
Pleasantness level;
High pleasantness level;
Unpleasantness level.

Six dimensions (dim 1-dim 6) are linked to the first two levels (pleasantness and high pleasantness), as shown always in FIG. 3 and a group of four suitably selected emotional adjectives belongs to each dimension.

It is important to notice that the selection of emotional adjectives has followed actually a precise parameter, even being arbitrary.

First of all, a semantic research has been carried out, for adjectives able to describe the qualities of the product and, at the same time, suitable to represent the sensations inspired by the tasting experiences.

For example, the term “full-bodied” can be a suitable term for an organoleptic classification or for a wine technique but instead it does not describe an emotional state.

Therefore, the selected adjectives describe well both a product and an emotional state at the same time.

Provided that, six groups have been selected for the first two levels (the so-called “dimensions”) and each dimension owns four emotional elements in its totality (i.e. four emotional adjectives with high semantic affinity between those determined and selected).

Instead, the unpleasantness level has been represented with four dimensions (dim 13-dim 16) and, as usual, four adjectives for each dimension.

In reality, the unpleasantness level could be represented by an equal number of dimension to the above pleasantness levels. Nevertheless, it has been found that a level represented by four dimensions and four emotional adjectives are more than sufficient for its full representation. This is a correct element obtained statistically, as the unpleasantness (i.e. the negative judgement in general) amounts approximately to 25% of all the judgements. This is inferable from literature, such as TripAdvisor, considered also that the user which makes such a review is always inclined to a positive judgement.

Therefore, it has been believed that the emotional level of unpleasantness results in being well represented by four dimensions in the algorithm of overall emotional calculation, even if an inferior or superior number can be implemented without distancing itself from the present inventive concept.

The levels of pleasantness and high pleasantness have been believed to be statistically fully represented with 24 adjectives per level (i.e. four adjectives per dimension).

Nevertheless, it is obvious that a different number could be implemented without distancing itself from the present inventive concept.

Provided that, the system has the aforementioned levels and related dimensions in its algorithm of calculation, proposed to the person who tries and wants to review the product, in order to obtain a sequence of emotional adjectives and their intensities best representing the product. Obviously, the judgement can be modified as soon as the reviews increase.

The unpleasantness level deducts positive judgement to levels of pleasantness and high pleasantness, if it is taken into account.

The mode of operation of such a reviewing method is described below, also by means of flow charts, and successively, more specifications are given on the algorithm of specific operation.

FIG. 7 shows a screenshot as example of wine evaluation (the example shows VERNACCIA DI SAN GIMIGNANO).

The button “Proceed” allows to open the following evaluation pages.

Preferably, the system requires to authenticate the own judgement with a picture of the product, thus acquiring it.

As per FIG. 9, the screenshot concerning the technical evaluation opens with three simple parameters of color, sense of smell, taste and then concerning the purely technical field of evaluation. By scrolling the related scrollbar, the user can give a judgement from 0 to 5 for each kind of these characteristics.

The button “continue” allows to proceed with the emotional evaluations related to profiles of pleasantness and high pleasantness, that is evaluate the type and intensity of emotions awakened while using the product.

FIG. 10 shows the profile related to pleasantness and high pleasantness, by highlighting six emotional adjectives for each field of pleasantness and high pleasantness.

The number of six emotional adjectives is not random but it is strictly linked to the planning project of representing each profile with six dimensions and four adjectives for each dimension.

In particular, in connection with each person reviewing a product, the system displays an adjective for each dimension and these adjectives are selected randomly between the four ones belonging to the dimension.

Therefore, if the person X reviews a wine and the emotional adjectives of FIG. 10 are shown for the profile of pleasantness and high pleasantness, other adjectives will appear to a subject Y reviewing the same product for every one of the six dimensions for profile.

In this way, the system succeeds in implementing a wide range of different judgements, thus being able to develop, modify and make the emotional evaluation of the product precise.

Therefore, the subject can give a classic evaluation by scrolling the related scrollbar from 0 to 5, as already said.

As shown in the phases numbered from 7 to 10 of FIG. 11, the system allows to resume the given evaluation and requests if it is required to make some changes and/or review negatively.

If a user wants to review negatively, then it is possible to push a suitable button which controls the opening of the screenshot 8 of FIG. 11 and with the four emotional adjectives, each one corresponding to a dimension of the overall four ones.

Also in this case, the selection of the emotional intra-dimensional adjectives is random, for each one of the four dimensions.

Once such a rate is given, as usual by scrolling the chart to give a value of judgement from 0 to 5, the system displays an overall screenshot (that on FIG. 9) wherein the given evaluation is resumed.

This given evaluation will be sent to the database and will be processed according to the algorithm described further, in such a manner that such a product is characterized in its entirety by at least one or more adjectives and related intensities, representing it at most in emotional terms.

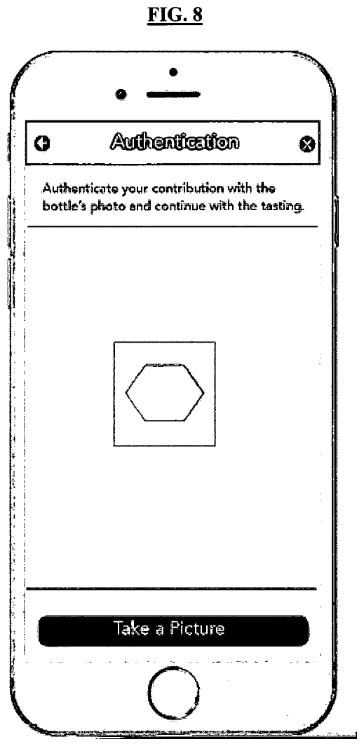

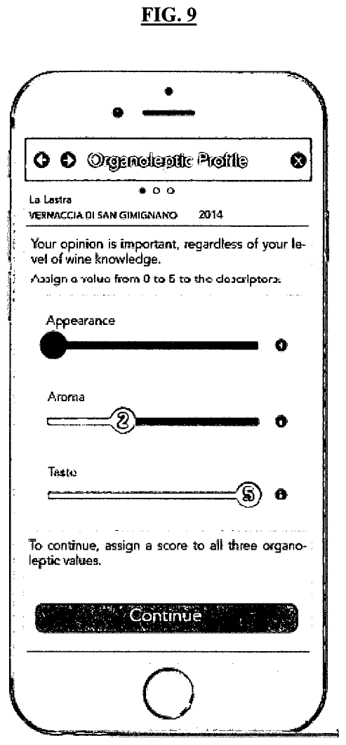

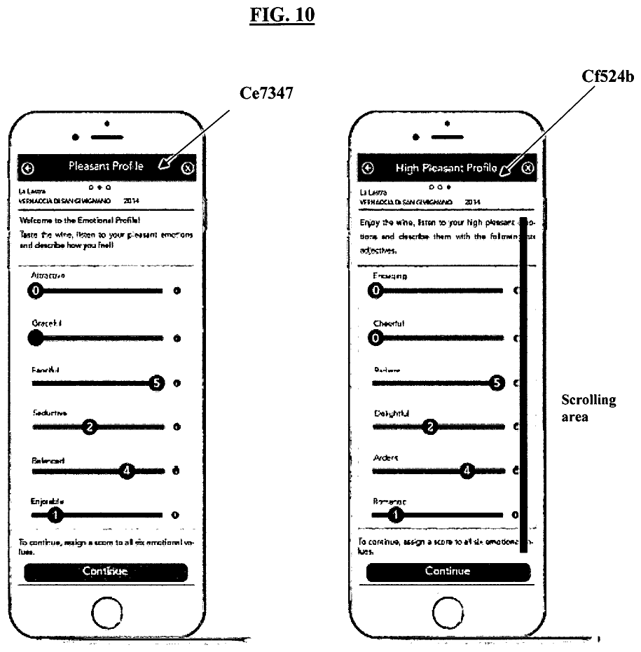

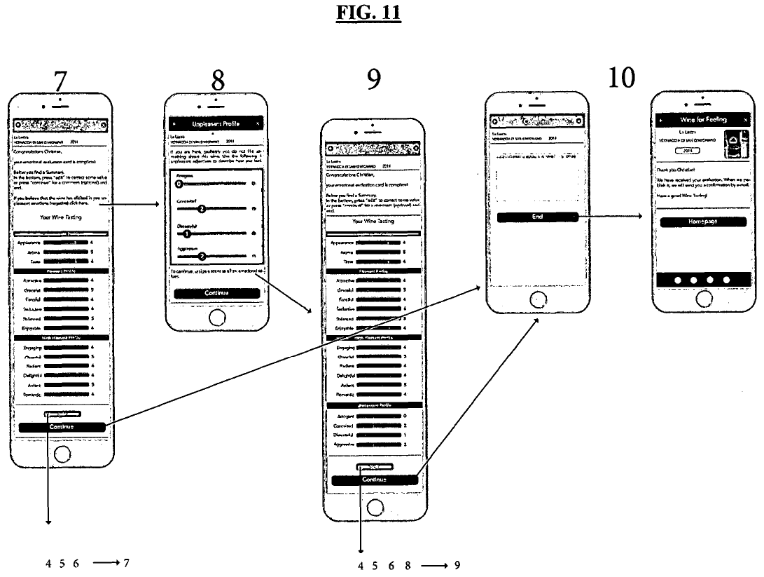

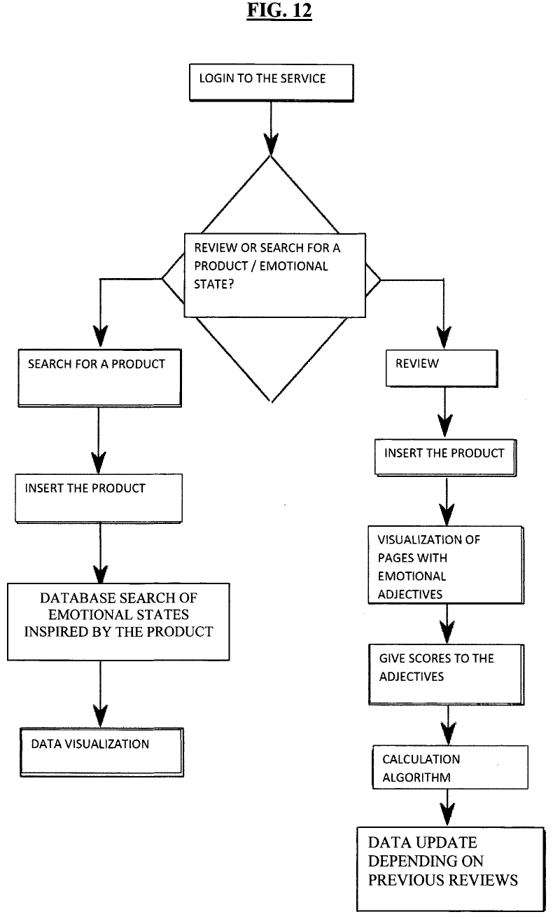

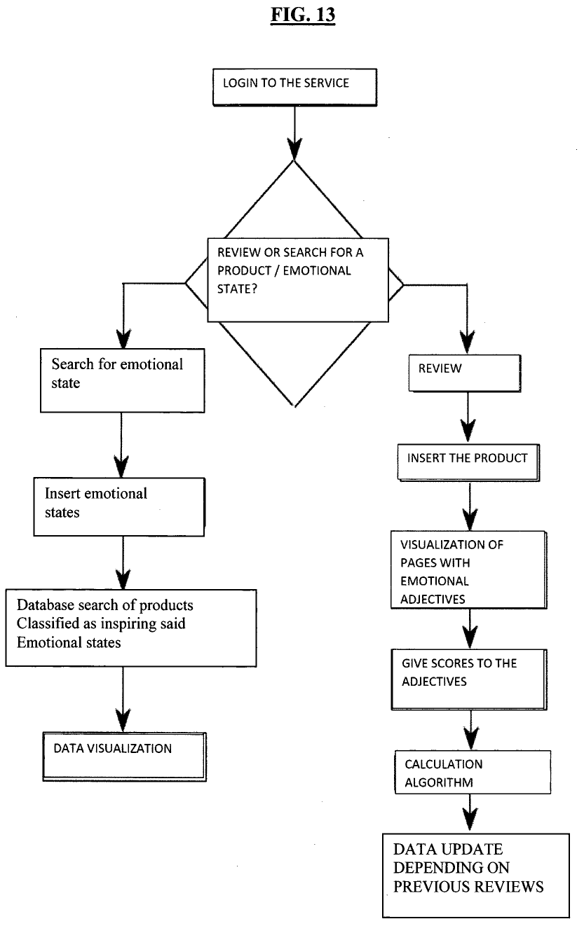

Lastly, the flow charts of FIGS. 12 and 13 resume the main steps of the present invention.

FIG. 12 shows a Log-in phase to the service and the possibility to review a product or to search for product depending on the emotional state that is wanted to feel (FIG. 13) or to search for a specific product to verify which emotional state is awakened by it (FIG. 12).

Once logged in, it is possible to insert a specific product (wine, for example) and launch a research on the database which will highlight one or more adjectives, if there are, representing the emotional state of such a product.

As alternative, the flow charts of FIG. 13 is equal to that of FIG. 12, except that the left branch is modified as it refers to the research of products depending on the emotional state which a person wants to feel.

Instead, the right part of the two flow charts is equal and concerns the review of a product.

It is required to insert a product and the judgement (from 0 to 5) for each emotional adjective highlighted by the system both for the profile of pleasantness and for high pleasantness. The same applies to the technical profile and for the optional profile of unpleasantness, if the user wants to insert a negative judgement.

The algorithm acquires the data for the rate and processes them, thus updating the overall judgement.

A substantial difference of the present method is remarkable in comparison to other known reviewing systems.

In general, each traditional reviewing system has a simple list which includes all the judgements that can be read one by one. This does not give a clear idea of the real value of the product, as no user can read all the judgements and verify objectively the overall value of the product. He can only get an overall idea, generally by reading some of the available judgements. Moreover, the judgements are subjective and variable and so unmethodical.

Systems like TripAdvisor are more innovative and they give de facto an overall score which allows to understand more or less the quality of the reviewed product.

However, the aforementioned systems are not able to link a judgement to an emotional state which at the same time can represents well also the product itself. In that sense, they do not have any utility for a research aiming to find an alternative product to a classic medicine, whether a subject wants to modify its psychologic mood.

The present method, through the use of a specific algorithm, fixes some parameters of judgements defined by specific emotional adjectives and by a value which can be given to them by the user depending on its own emotional level. The value given by the user is then processed by the algorithm which gives a score to each judgement in combination with the previous score obtained from the other judgement. Therefore, in that sense, a precise mathematical measurement of the product qualities is obtained linked to the emotional state and such that, the person referring to such a system has a precise and not subjective estimate of the product properties and of what awakens contextually.

By describing the algorithm in details, FIGS. from 4 to 6 helps to understand the type of the processed algorithm.

In particular, at the moment when the system allows to evaluate a predetermined product (wine, for example) the server suggests randomly an adjective for each dimension.

FIG. 4 shows also the existence of the purely technical profile which can be included and is characterized by three simple dimensions.

FIG. 4 shows the related describing elements representing the emotional adjectives related to each dimension.

As per FIG. 6, some constants are included in the calculation process.

The aforementioned constants are arbitrary and determined for each specific good/service and allow de facto to obtain a weight in thousandths for each adjective.

Such a weight is at the basis of the calculation.

In particular, as shown in the adjacent column, an evaluation is made by inserting some judgements from 0 to 5 on the adjectives visualized by the user.

If for example the judgment given to the sight is 4, then its weight will be (4/5) out of 80 and then 64.

This is made for all the emotional adjectives, obtaining a final sum column, allowing to give a final score in hundredth of each single review.

The final score allows to have an overall estimate of how much a product can instill emotions in general.

Therefore, a first possible visualization of the result can be such an overall score.

However, specifically, the algorithm visualizes the full emotional profile through the most representative emotional adjectives and related intensities given by the user and that is much more important.

In order to do that, with reference to FIG. 3, it is highlighted here again that there are twelve dimensions from the level of pleasantness and high pleasantness and four further dimensions of unpleasantness. Therefore, there are sixteen dimensions in total.

This means that each person making a review will be asked to give a score from 0 to 5 on sixteen adjectives for a specific wine he is reviewing and each adjective belongs to a dimension.

The attribution of a score to the 12 pleasant dimensions is compulsory, while the score given to the 4 negative dimensions is optional. Whether the “unpleasant” part is not filled in, the system gives a value 0 to each negative dimension by default.

FIG. 5A shows some of the sixteen adjectives, as each one of them belongs to a dimension and each dimension has four adjectives actually.

In that sense, as already said, an adjective of the four possible ones for each dimension appears randomly while voting, for each voting subject. In that sense, the subject (A) will presumably rate adjectives different from those ones rated by a subject (B). However, the four adjectives for each dimension are not very different each other in terms of meaning. This does not cause loss of meaning in the rate, thus maintaining a wide semantic variability of the emotional lexicon.

For simplicity purposes, FIG. 5A shows sixteen adjectives and each column is a rate of a subject.

Therefore, the system generates a string of numbers for each dimension, corresponding to given rates, and from which a final rate for each dimension can be obtained as weighted average. FIG. 5B shows an example of final rate, thus showing the average value of each string, taking into account further corrective factors, such as the standard deviation as representation of the context effect.

The standard deviation (the so-called SD) is well known in itself and for this reason it is not described here further.

The context effect is a standard deviation linked to each dimension.

At this point, the system is able to reorganize for each reviewed product the twelve dimensions in descending order from the most rated one to the less voted one, reviewing then the most significant adjectives.

In particular, the attribution of ratings to the adjectives of each dimension is processed by the system to order the ratings, both intra-dimensionally and extra-dimensionally. Intra-dimension means that time after time the system selects the adjective (from the four numbered ones) with the highest score as representative of the dimension.

Extra-dimension means that the system organizes the dimensions in descending order, so that they have at least a score equal to or more than 1.

For example, the first string of FIG. 5B has the highest score of the pleasantness profile, corresponding to the adjective “Curious”. This means that, until now the dimension containing he adjective “Curious” (and therefore the dimension_3) is at the first place of the pleasantness profile. Also, “Curious” is the most representative adjective inside the same dimension (dim_3), i.e. it is the adjective which received the highest score between the intra-dimensional adjectives. The adjective “Pleasant” is at the second place (score 4,04). This entails that the dimension_5 is at the second place of the pleasantness profile and it is mainly represented by the adjective “Pleasant”.

It is carried on until the end by highlighting, on choice and not compulsorily, the dimensions having at least a score equal to 1 or higher than 1 in descending order.

Moreover, the three most significant dimensions are highlighted with their most representative adjectives. In the example of FIG. 5B, the three most significant adjectives are: Happy, Pleasant and Elegant.

In this way, both an overall visualization of each dimension and a detailed one occur.

It is obvious that such a statistic calculation is implemented for each rating and therefore it can modify the result of the classification.

In that case, the algorithm memorizes all the scores for each adjective/dimension and verifies which adjective is most important for the dimension, by means of the statistical analysis of the variance (average value and standard deviation) and its related intra-dimensional comparison. Then, it verifies which adjective (and their related intensities) are most significant for the representation of the product, by means of the extra-dimensional comparison, in order to visualize them in their description and intensity.

For example, if the adjective “Interesting” results in having the highest score over a hundred evaluations, the server will certainly memorize that the dimension 1 is represented by the value “Interesting” and visualizes said product as “Interesting”. Therefore, it makes feel “Interesting” who drinks the wine, with an intensity level equal to the score attributed by the statistical calculation, as average value filtered from the context effect. This last one also is graphically represented by the system.

However, other algorithms may be implemented, without distancing themselves from the present inventive concept.

1-12. (canceled)

13. A method of reviewing a product or a service, comprising:
accessing a server provided with a database to memorize/process one or more data, said step of accessing being made with an electronic device adapted to connect to the Internet;
sending to the server, through the electronic device, a review request of a predetermined product/service, the server sending to the device a sequence of elements of judgment correlated to the product/service, to which a user attributes a numerical evaluation comprised between a pre-established minimum value and a maximum value;
inserting, through said electronic device, said numerical evaluation for each element of judgment and sending said numerical evaluation to the server; and
processing said numerical evaluation by the server through a specific algorithm so as to extrapolate a classification of elements of judgment correlated to said product/service based on the evaluation received and possible previous evaluations,
wherein said elements of judgment are selected so that each one of them is a term indicative of an emotional state, which the user can feel as the user tries the product/service, and to which the user gives a predetermined numerical evaluation.

14. The method, as per claim 13, wherein the numerical evaluation is as a function of the emotional state that the user feels.

15. The method, as per claim 13, further comprising a a phase of sending to the server of a request of visualization of features of the pre-determined product/service, the server doing a search in the database and returning possible emotional terms correlated to the pre-determined product/service stored in memory.

16. The method, as per claim 13, further comprising of sending to the server of a request of visualization of one or more products/services based one of more indicative terms of an emotional state, the server doing a search in the database and returning a list of possible products/services corresponding to said one or more emotional states.

17. The method, as per claim 13, wherein there are comprised a pre-determined number of groups, each group comprising a predetermined number of said terms, the server during each review sending to the device a term for each group to which to attribute said numerical evaluation.

18. The method, as per claim 17, wherein said term, at each review, is obtained at random from the group to which said term belongs.

19. The method, as per claim 17, wherein there are comprised six groups indicative of an emotional state of pleasure and further six groups indicative of an emotional state of higher pleasure.

20. The method, as per claim 19, wherein said algorithm determines a standard deviation of said terms within each group.

21. The method, as per claim 17, wherein said algorithm determines a ranking of the groups, visualizing for each group in descending order the term with a highest score.

22. The method, as per claim 21, wherein the score is numerical and comprised between 0 and 5.

23. The method, as per claim 13, wherein, before the review of a product, a picture of the product to be reviewed is provided.

24. The method, as per claim 13, wherein the product is an oenological product.
